(19) United States
(12) Patent Application Publication
(10) Pub. No.: US 2009/0297902 A1
(43) Pub. Date: Dec. 3, 2009

(54) Cell Stack and Fuel Cell Device Provided with the Same

(75) Inventors: Tomohiro Hirayama, Ome-shi (JP); Terumasa Nagasaki, Ome-shi (JP); Nobuyasu Tajima, Akishima-shi (JP); Takahiro Suzuki, Tokyo (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Kabushiki Kaisha Toshiba, Tokyo (JP)

(21) Appl. No.: 12/337,448

(22) Filed: Dec. 17, 2008

(30) Foreign Application Priority Data
May 28, 2008 (JP) 2008-139546

(51) Int. Cl. H01M 8/04

(52) U.S. Cl. 429/26

(57) ABSTRACT

According to one embodiment, a cell stack of a fuel cell device comprises a positive electrode including a anode separator, and a pair of anode plates laminated opposite first and second contact surfaces of the anode separator, a pair of negative electrodes laminated individually on the opposite sides of the positive electrode, and electrolyte layers. The negative electrode includes a cathode plate opposed to each corresponding anode plate with a gap therebetween and a cathode separator provided with a contact surface opposed to the cathode plate. The anode separator includes first fuel channels formed in the first contact surface, second fuel channels formed in the second contact surface, and cooling channels formed between the first and second contact surfaces and through which a coolant is circulated. The cathode separator includes a plurality of air channels formed in the contact surface and through which air is supplied to the cathode plate.

### CROSS-REFERENCE TO RELATED APPLICATIONS

This application is based upon and claims the benefit of priority from Japanese Patent Application No. 2008-139546, filed May 28, 2008, the entire contents of which are incorporated herein by reference.

### BACKGROUND

1. Field

One embodiment of the present invention relates to a cell stack of a fuel cell used as an energy source for an electronic apparatus or the like and a fuel cell device provided with the same.

2. Description of the Related Art

Presently, secondary batteries, such as lithium ion batteries, are mainly used as energy sources for electronic apparatuses, e.g., notebook computers, mobile devices, etc. In recent years, small, high-output fuel cells that require no charging have been expected as new energy sources to meet the demands for increased energy consumption and prolonged use of these electronic apparatuses with higher functions. Among various types of fuel cells, direct methanol fuel cells (DMFCs) that use a methanol solution as their fuel, in particular, enable easier handling of the fuel and a simpler system configuration, as compared with fuel cells that use hydrogen as their fuel. Thus, the DMFCs are noticeable energy sources for the electronic apparatuses.

Usually, a single cell of a DMFC is provided with a membrane electrode assembly (MEA) on each surface of an electrolyte layer, such as an electrolyte plate or a solid polymer electrolyte membrane. The MEA integrally includes an anode and a cathode each formed of a catalyst layer and a carbon paper. A cell stack is formed by alternately laminating a plurality of separators and single cells to one another. Each separator is provided with fuel channels on the principal surface side that faces the anode of the single cell and air channels on the principal surface side that faces the cathode of the single cell. As described in Jpn. Pat. Appln. KOKAI Publication No. 2005-293981, for example, end separators with pipes for supplying a fuel or an oxidizer are laminated individually to the upper and lower surfaces of a cell stack, and a clamping plate is laminated to the outside of the resulting structure. A cell stack unit is obtained by integrating the entire structure with tightening tools, such as tightening screws.

The fuel and the oxidizer are supplied to the anode and the cathode, respectively, through grooves formed in each separator. Oxidation of the fuel occurs in the anode such that methanol is oxidized by reaction with water, whereupon carbon dioxide, protons, and electrons are produced. The protons are transmitted through the polymer electrolyte membrane and move to the cathode. In the cathode, oxygen gas in air is coupled to hydrogen ions and electrons and reduced to water. During this process, electrons flow through an external circuit and a current is drawn.

In the fuel cell constructed in this manner, the cell stack tends to produce heat, thereby continually increasing the temperature of the cell stack. In order to generate electricity efficiently, the cell stack is cooled and kept at an optimum temperature for the generation of electricity.

As described in, for example, Jpn. Pat. Appln. KOKAI Publication No. 2005-129469, therefore, there is provided a cell stack in which cooling plates arranged between adjacent separators are provided with cooling channels through which cooling water is to be run. According to this cell stack, singles cells can be cooled and kept at an appropriate temperature by running the cooling water through the cooling channels.

Having the cooling plates sandwiched between the separators, however, the cell stack described above is made thicker overall. This prevents reduction in the overall size of the fuel cell.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram schematically showing a configuration of a fuel cell device according to a first embodiment of the invention;

FIG. 2 is an exemplary perspective view showing a cell stack of the fuel cell device;

FIG. 3 is an exemplary exploded perspective view showing a unit stack of the cell stack;

FIG. 4 is an exemplary view schematically showing a single cell of the cell stack;

FIG. 5 is an exemplary perspective view showing a cell stack according to a second embodiment of the invention; and

FIG. 6 is an exemplary block diagram schematically showing a configuration of a fuel cell device according to a third embodiment of the invention.

### DETAILED DESCRIPTION

Various embodiments according to the invention will be described hereinafter with reference to the accompanying drawings. In general, according to one embodiment of the invention, a cell stack of a fuel cell device comprises: a positive electrode including a plate-shaped anode separator, which is provided with a first contact surface and a second contact surface opposed to each other, and a pair of anode plates laminated opposite the first and second contact surfaces, respectively, of the anode separator; a pair of negative electrodes laminated individually on the opposite sides of the positive electrode and each including a cathode plate opposed to each corresponding anode plate with a gap therebetween and a plate-shaped cathode separator provided with a contact surface opposed to the cathode plate; and electrolyte layers each sandwiched between the anode plate and the cathode plate. The anode separator includes a plurality of groove-like first fuel channels which are formed in the first contact surface and through which a fuel is supplied to the anode plate corresponding thereto, a plurality of groove-like second fuel channels which are formed in the second contact surface and through which the fuel is supplied to the anode plate corresponding thereto, and cooling channels which are formed between the first and second contact surfaces and through which a coolant is circulated. The cathode separator includes a plurality of groove-like air channels which are formed in the contact surface and through which air is supplied to the cathode plate.

According to another aspect of the invention, there is provided a fuel cell device comprising: an electromotive section comprising a cell stack and configured to generate electricity in consequence of a chemical reaction; a fuel tank configured to store a fuel; a fuel supply section configured to supply the fuel from the fuel tank to the cell stack; an air supply section configured to supply air to the cell stack; and a coolant supply section configured to supply a coolant to the cell stack. The cell stack comprises a positive electrode including a plate-shaped anode separator, which is provided with a first contact surface and a second contact surface opposed to each other, and a pair of anode plates laminated opposite the first and second contact surfaces, respectively, of the anode separator, a pair of negative electrodes laminated individually on the opposite sides of the positive electrode and each including a cathode plate opposed to each corresponding anode plate with a gap therebetween and a plate-shaped cathode separator provided with a contact surface opposed to the cathode plate, and electrolyte layers each sandwiched between the anode plate and the cathode plate, the anode separator including a plurality of groove-like first fuel channels which are formed in the first contact surface and through which a fuel is supplied to the anode plate corresponding thereto, a plurality of groove-like second fuel channels which are formed in the second contact surface and through which the fuel is supplied to the anode plate corresponding thereto, and cooling channels which are formed between the first and second contact surfaces and through which a coolant is circulated, the cathode separator including a plurality of groove-like air channels which are formed in the contact surface and through which air is supplied to the cathode plate.

A fuel cell device according to a first embodiment of this invention will now be described in detail with reference to the accompanying drawings.

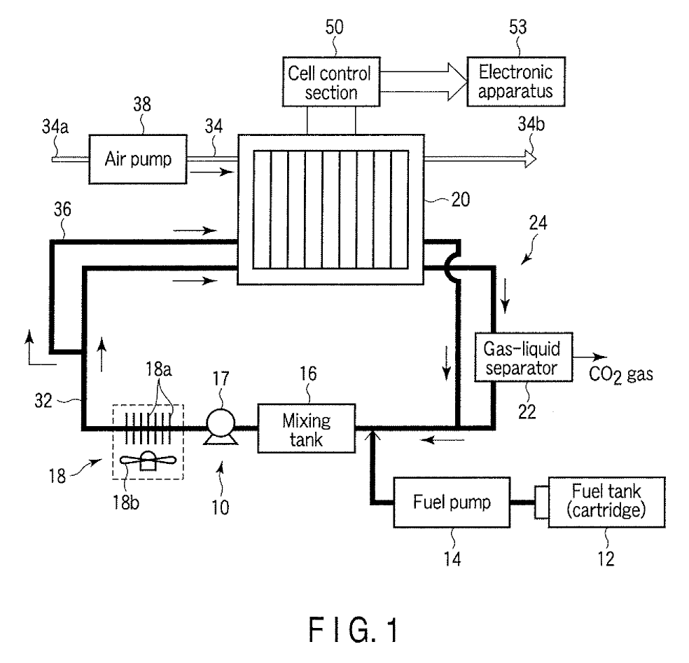

FIG. 1 schematically shows a configuration of the fuel cell device. As shown in FIG. 1, a fuel cell device 10 is constructed as a DMFC that uses methanol as its liquid fuel. The device 10 is provided with a cell stack 20, a fuel tank 12, a circulatory system 24, and a cell control section 50. The cell stack 20 constitutes an electromotive section. The circulatory system 24 supplies the fuel and air to the cell stack. The cell control section 50 controls the operation of the entire fuel cell device.

The fuel tank 12 has a sealed structure and is formed as a fuel cartridge that is removably attached to the fuel cell device 10. The tank 12 contains high-concentration methanol for use as the liquid fuel. The fuel tank 12 can be replaced with ease when the fuel has been used up.

The circulatory system 24 includes an anode channel 32, a cathode channel 34, a coolant channel 36, and a plurality of ancillary components. The fuel that is supplied from the fuel tank 12 is run through the anode channel 32 via the cell stack 20. A gas that contains air is circulated through the cathode channel 34 via the cell stack 20. The coolant channel 36 diverges from the anode channel 32, and some of the fuel is circulated through the coolant channel 36 via the cell stack 20. The ancillary components are incorporated in the anode and cathode channels 32 and 34. The anode channel 32, coolant channel 36, and cathode channel 34 are each formed of a pipe or the like.

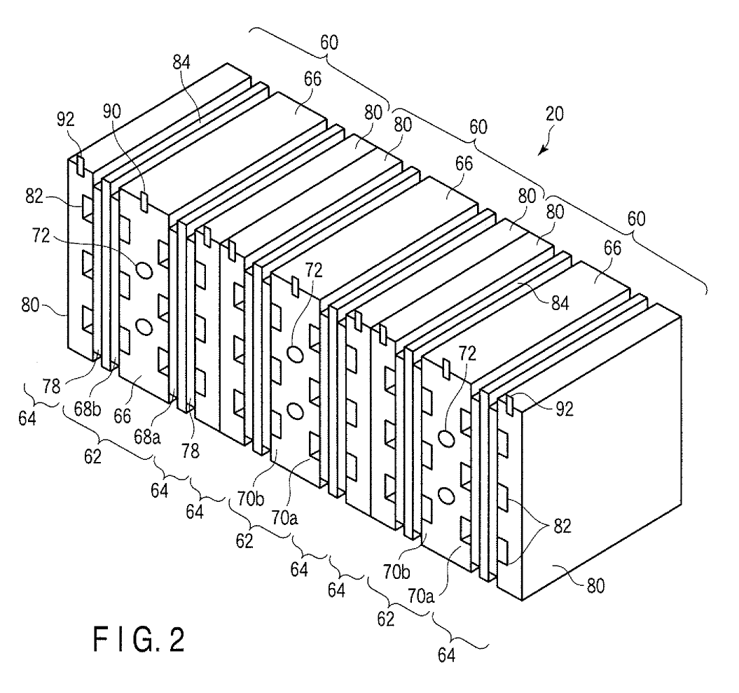

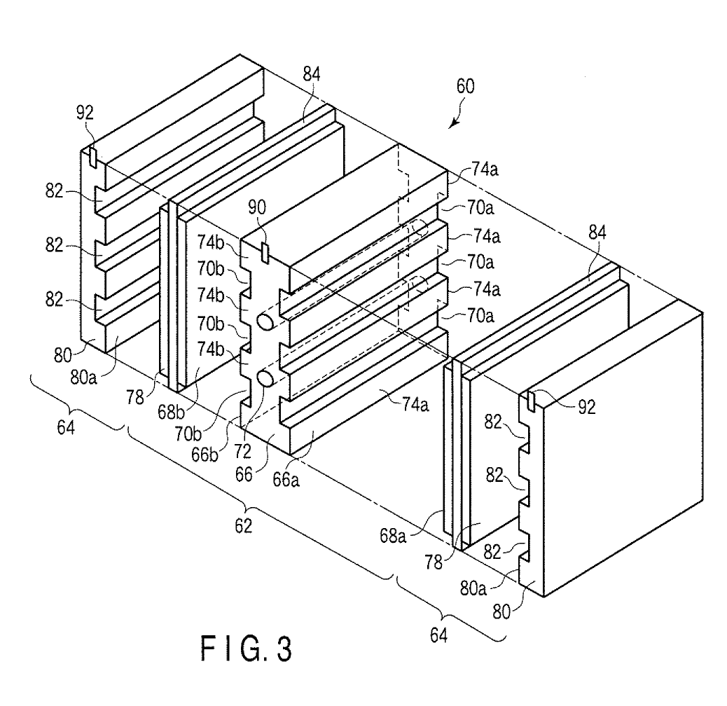

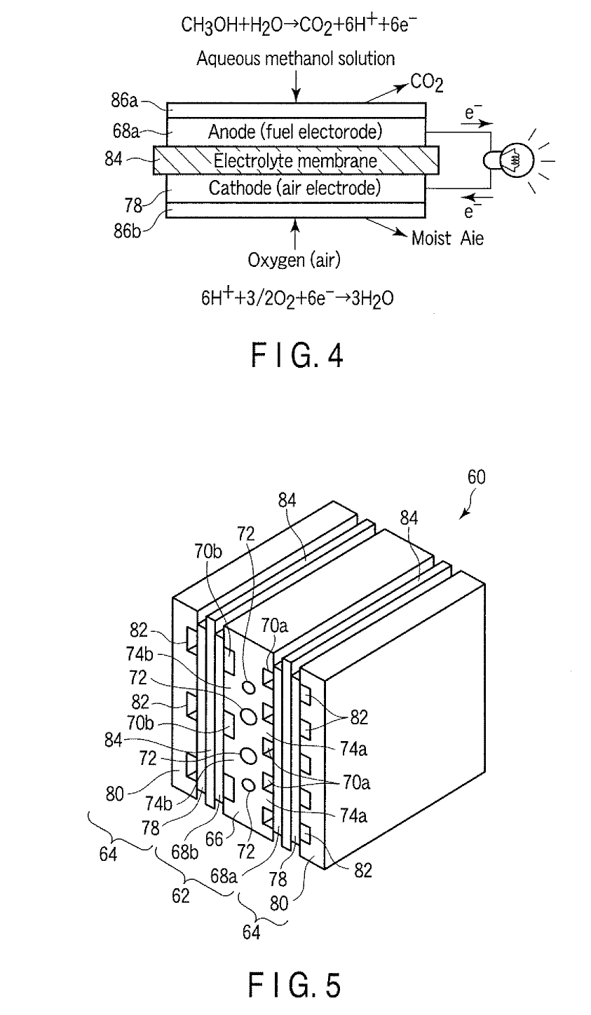

FIG. 2 shows a laminated structure of the cell stack 20, FIG. 3 is an exploded view showing the cell stack, and FIG. 4 typically shows an electricity generating reaction of a unit cell that constitutes the cell stack. As shown in FIGS. 2 and 3, the cell stack 20 is formed by laminating a plurality of, e.g., three, unit stacks 60.

Each unit stack 60 includes a double-sided positive electrode 62 and a pair of negative electrodes 64 laminated individually to the opposite sides of the positive electrode 62. The double-sided positive electrode 62 is provided with an anode separator 66 and a pair of rectangular anode plates (fuel electrodes) 68a and 68b. The anode separator 66 is a rectangular plate having first and second contact surfaces 66a and 66b that are opposed to each other. The anode plates 68a and 68b are laminated so as to face the first and second contact surfaces 66a and 66b, respectively, of the anode separator 66.

The anode separator 66 includes groove-like first fuel channels 70a formed in the first contact surface 66a, groove-like second fuel channels 70b formed in the second contact surface 66b, and cooling channels 72 formed between the first and second contact surfaces 66a and 66b. The fuel is supplied to the anode plate 68a through the first fuel channels 70a. The fuel is supplied to the anode plate 68b through the second fuel channels 70b. A coolant is circulated through the cooling channels 72.

A plurality of, e.g., three, first fuel channels 70a extend parallel to one side of the anode separator 66 and are arranged at predetermined intervals at right angles to the one side. A plurality of, e.g., three, second fuel channels 70b extend parallel to the one side of the anode separator 66 and the first fuel channels 70a and are arranged at predetermined intervals at right angles to the one side. In the present embodiment, the first and second fuel channels 70a and 70b are formed symmetrically with respect to the central axis of the anode separator 66.

The anode separator 66 includes first ribs 74a and second ribs 74b. The first ribs 74a are situated on either side of the first fuel channels 70a and constitute the first contact surface 66a. The second ribs 74b are situated on either side of the second fuel channels 70b and constitute the second contact surface 66b. The first and second ribs 74a and 74b extend parallel to the first and second fuel channels 70a and 70b.

The cooling channels 72 penetrate the anode separator 66 and extend parallel to the first and second fuel channels 70a and 70b. The cooling channels 72 are formed between the first and second contact surfaces 66a and 66b of the anode separator 66, and especially in regions where the first and second ribs 74a and 74b overlap one another. Specifically, each cooling channel 72 is provided on the same straight line with its corresponding first and second ribs 74a and 74b along the thickness of the anode separator 66.

On the other hand, the pair of negative electrodes 64 that are laminated individually on the opposite sides of the double-sided positive electrode 62 individually include rectangular cathode plates (air electrodes) 78 opposed to the anode plates 68a and 68b with gaps therebetween and rectangular cathode separators 80 each having a contact surface 80a opposed to each corresponding cathode plate 78. The contact surface 80a of each cathode separator 80 is formed with groove-like air channels 82 through which air is supplied to the cathode plate 78.

A plurality of, e.g., three, air channels 82 extend parallel to one side of each cathode separator 80 and are arranged at predetermined intervals at right angles to the one side. Although the air channels 82 extend parallel to the first and second fuel channels 70a and 70b in the present embodiment, they may alternatively be formed so as to extend at right angles to the fuel channels.

Each cathode plate 78 is laminated to its corresponding cathode separator 80 so as to be in contact with the contact surface 80a of the cathode separator. Rectangular polymer electrolyte membranes 84 as electrolyte layers are sandwiched individually between one of the cathode plates 78 and the anode plate 68a and between another cathode plate 78 and the anode plate 68b.

The anode separator 66 is provided with a positive electrode terminal 90 for drawing current, and each cathode separator 80 is provided with a negative electrode terminal 92 for drawing current.

As shown in FIG. 4, each anode plate 68a (68b) is formed with a fuel diffusion layer 86a, and each cathode plate 78 is provided with a porous gas diffusion layer 86b. Each polymer electrolyte membrane 84 has an area greater than those of the anode plates 68a and 68b and each cathode plate 78.

As shown in FIG. 2, the unit stacks 60 constructed in this manner are laminated in a line such that the cathode separators 80 are opposed to one another. The resulting laminated structure is supported by a frame (not shown), which is formed with a plurality of channels that communicate with the fuel channels, air channels, or cooling channels.

As shown in FIG. 4, the supplied fuel (aqueous methanol solution) and air chemically react with each other in the polymer electrolyte membranes 84 between the anode plates 68a and 68b and the cathode plates 78. Thereupon, electricity is generated between the anode plates and the cathode plates. As this electrochemical reaction progresses, carbon dioxide and water are produced as reaction byproducts on the sides of the anode plates 68a and 68b and the cathode plates 78, respectively. Electricity generated in the cell stack 20 is supplied to an external device, such as an electronic apparatus 53, through the cell control section 50.

As shown in FIG. 1, an upstream end 34a and a downstream end 34b of the cathode channel 34 individually communicate with the atmosphere. The cathode channel 34 is connected to the air channels 82 of the cell stack 20. The ancillary components incorporated in the cathode channel 34 include an air pump 38 that is connected to the cathode channel 34 on the upstream side of the cell stack 20. The air pump 38 constitutes an air supply section that supplies air to the cathode.

The ancillary components incorporated in the anode channel 32 includes a fuel pump 14 pipe-connected to a fuel inlet of the fuel tank 12, a mixing tank 16 pipe-connected to an output portion of the fuel pump 14, and a liquid pump 17 connected to an output portion of the mixing tank 16. These ancillary components further include a heat exchanger 18 incorporated in the anode channel 32 between the liquid pump 17 and the cell stack 20 and a gas-liquid separator 22 connected to the anode channel 32 between the output side of the cell stack 20 and the mixing tank 16. The mixing tank 16, along with the fuel tank 12, constitutes a part of a fuel tank according to the present invention.

An output portion of the liquid pump 17 is connected to the fuel channels 70a and 70b of the cell stack 20 by the anode channel 32. The fuel pump 14 and the liquid pump 17 constitute a fuel supply section that supplies the fuel to the cell stack 20 and a coolant supply section that supplies some of the fuel as a coolant to the cell stack 20, respectively.

The heat exchanger 18 is incorporated in the anode channel 32 between the output portion of the liquid pump 17 and the inlet side of the cell stack 20. The heat exchanger 18 includes, for example, a plurality of radiator fins 18a, which are arranged around a pipe that forms the anode channel 32, and a cooling fan 18b for delivering cooling air to the radiator fins. The heat exchanger 18 removes heat from the fuel that flows through the anode channel 32, thereby cooling the fuel.

The output sides of the fuel channels 70a and 70b of the cell stack 20 are connected to an input portion of the mixing tank 16 through the anode channel 32 and the gas-liquid separator 22. Exhaust byproducts that are discharged from the anode plates 68a and 68b of the cell stack 20, that is, carbon dioxide and unreacted aqueous methanol solution, are fed to the gas-liquid separator 22, in which the liquid is separated from the gas. The separated aqueous methanol solution is returned to the mixing tank 16 through the anode channel 32, while the carbon dioxide is discharged to the outside.

The coolant channel 36 diverges from the anode channel 32 at a point between the heat exchanger 18 and the cell stack 20. After passing through the cooling channels 72 of the cell stack 20, the coolant channel 36 joins the anode channel 32 between the cell stack and the mixing tank 16, e.g., between the gas-liquid separator 22 and the mixing tank.

The cell control section 50, which is connected to the positive and negative electrode terminals 90 and 92, supplies the electricity generated in the cell stack 20 to the electronic apparatus 53, measures the voltage of each single cell, and performs current control to draw a current from the cell stack.

If the fuel cell device 10 constructed in this manner is used as an energy source for the electronic apparatus 53, the fuel tank 12 that contains methanol is mounted and connected to the circulatory system 24 of the fuel cell device. In this state, generation of electricity by the fuel cell device 10 is started. In this case, the fuel pump 14, liquid pump 17, and air pump 38 are driven under the control of the cell control section 50. The fuel pump 14 supplies the high-concentration fuel from the fuel tank 12 to the mixing tank 16 through the anode channel 32. The fuel is mixed with water in the mixing tank 16 and diluted to a predetermined concentration. The aqueous methanol solution diluted in the mixing tank 16 is supplied to the anode plates 68a and 68b of the cell stack 20 through the anode channel 32 and the fuel channels 70a and 70b in the cell stack 20 by the liquid pump 17.

On the other hand, the atmosphere or air is drawn into cathode channel 34 through its upstream end 34a by the air pump 38. After passing through a suction filter (not shown), the air is supplied to the cell stack 20 through the cathode channel 34 and then to the cathode plates 78 of the cell stack 20 through the air channels 82 of the cell stack.

The aqueous methanol solution and the air supplied to the cell stack 20 react electrochemically with each other in the polymer electrolyte membranes 84 between the anode plates 68a and 68b and the cathode plates 78, thereby generating electricity between the anode and cathode plates. The electricity generated in the cell stack 20 allows a current to be drawn from the cell stack 20 by the cell control section 50 and supplied to the electronic apparatus 53.

As the electrochemical reaction progresses, carbon dioxide and water are produced as reaction byproducts on the sides of the anode plates 68a and 68b and the cathode plates 78, respectively, in the cell stack 20. The carbon dioxide produced on the anode plate side and the unreacted aqueous methanol solution are fed through the anode channel 32 to the gas-liquid separator 22, in which they are separated from each other. The aqueous methanol solution is delivered from the gas-liquid separator 22 to the mixing tank 16 through the anode channel 32 and used again for generation of electricity. The separated carbon dioxide is discharged from the gas-liquid separator 22.

Steam produced on the side of the cathode plates 78 of the cell stack 20 is discharged to the outside through the downstream end 34b of the cathode channel 34.

During the operation of the fuel cell device 10, on the other hand, the cell stack 20 tends to produce heat, thereby continually increasing the temperature of the cell stack. According to the fuel cell device 10 described above, the fuel that is supplied to the cell stack 20 by the liquid pump 17 is deprived of heat and cooled by the heat exchanger 18. Thereafter, some of the fuel is fed to the cooling channels 72 of the cell stack 20 through the coolant channel 36. As the fuel supplied as the coolant flows through the cooling channels 72, it cools the anode separator 66, thereby cooling the anode plates 68a and 68b on the opposite sides of the anode separator 66. Thereafter, the fuel flows through the coolant channel 36 into the anode channel 32 and is returned to the mixing tank 16. Thus, by supplying some of the fuel as the coolant to the cell stack 20 to cool it, the cell stack can be kept at a temperature suitable for electricity generation. As this is done, the anode plates 68a and 68b that produce a large amount of heat in the cell stack 20 can be cooled intensively.

According to the fuel cell device constructed in this manner, the cell stack 20 can be efficiently cooled if it is heated by the electricity generation. The cell stack 20 includes the anode separators each sandwiched between the pair of anode plates and is provided with the cooling channels through which the coolant is delivered to the anode separators. Thus, the coolant that flows through the cooling channels can cool the paired anode plates on either side. Further, it is unnecessary to provide any independent cooling plates that have cooling channels, and laminated members of the cell stack can be reduced in number, so that the cell stack can be made thin.

Each cooling channel is provided on the same straight line with its corresponding first and second ribs 74a and 74b along the thickness of the anode separator 66 and located on the central axis of the double-sided positive electrode. Therefore, the diameter of the cooling channel 72 can be set to a maximum physical value, so that the flow rate of the coolant can also be maximized. Accordingly, the cooling efficiency can be maximized. Thus, the channel diameter can be made much larger than that of each cooling channel 72 formed in a one-sided positive electrode, so that the thickness of the positive electrode can be minimized while ensuring efficient cooling.

Accordingly, there may be obtained a cell stack of a fuel cell, which can be cooled efficiently and made thinner, and a fuel cell device provided with the same.

Further, the cell stack 20 is configured to be supplied with the coolant through the coolant channel that diverges from the anode channel and by means of the pump that also serves for fuel supply. Therefore, it is unnecessary to provide any independent circulatory channel or any ancillary component, such as an independent liquid pump for running the coolant through the circulatory channel, so that the fuel cell device can be prevented from becoming larger. Thus, there may be obtained a fuel cell device that can be reduced in size and in which the cells can be cooled efficiently.

The following is a description of a cell stack according to a second embodiment.

FIG. 5 shows a unit stack of the cell stack of the second embodiment. According to the present embodiment, a unit stack 60 includes a double-sided positive electrode 62 and a pair of negative electrodes 64 laminated individually to the opposite sides of the positive electrode 62. The double-sided positive electrode 62 is provided with an anode separator 66 and a pair of rectangular anode plates 68a and 68b. The anode separator 66 is a rectangular plate having first and second contact surfaces that are opposed to each other. The anode plates 68a and 68b are laminated so as to face the first and second contact surfaces, respectively, of the anode separator.

The anode separator 66 includes groove-like first fuel channels 70a formed in the first contact surface, groove-like second fuel channels 70b formed in the second contact surface, and cooling channels 72 formed between the first and second contact surfaces. A fuel is supplied to the anode plate 68a through the first fuel channels 70a. The fuel is supplied to the anode plate 68b through the second fuel channels 70b. A coolant is circulated through the cooling channels 72.

A plurality of, e.g., five, first fuel channels 70a extend parallel to one side of the anode separator 66 and are arranged at predetermined intervals at right angles to the one side. A plurality of, e.g., three, second fuel channels 70b extend parallel to the one side of the anode separator 66 and the first fuel channels 70a and are arranged at predetermined intervals at right angles to the one side. In the present embodiment, the first and second fuel channels 70a and 70b are formed asymmetrically with respect to the central axis of the anode separator 66.

The anode separator 66 includes first ribs 74a and second ribs 74b. The first ribs 74a are situated on either side of the first fuel channels 70a and constitute the first contact surface 66a. The second ribs 74b are situated on either side of the second fuel channels 70b and constitute the second contact surface 66b. The first and second ribs 74a and 74b extend parallel to the first and second fuel channels 70a and 70b.

The cooling channels 72 penetrate the anode separator 66 and extend parallel to the first and second fuel channels 70a and 70b. The cooling channels 72 are formed between the first and second contact surfaces of the anode separator 66, and especially in regions where the first and second ribs 74a and 74b overlap one another.

The pair of negative electrodes 64 that are laminated individually on the opposite sides of the double-sided positive electrode 62 individually include rectangular cathode plates 78 opposed to the anode plates 68a and 68b with gaps therebetween and rectangular cathode separators 80 each having a contact surface opposed to each corresponding cathode plate 78. The contact surface of each cathode separator 80 is formed with groove-like air channels 82 through which air is supplied to the cathode plate 78.

Each cathode plate 78 is laminated to its corresponding cathode separator 80 so as to be in contact with the contact surface of the cathode separator. Rectangular polymer electrolyte membranes 84 as electrolyte layers are sandwiched individually between one of the cathode plates 78 and the anode plate 68a and between the other cathode plate 78 and the anode plate 68b.

Other configurations of the cell stack 20 of the second embodiment are the same as those of the foregoing first embodiment. Therefore, like reference numbers are used to designate like portions of these two embodiments, and a detailed description thereof is omitted.

Even though the first and second fuel channels 70a and 70b of the anode separator 66 are formed asymmetrically to each other, according to the second embodiment, the location of the cooling channels 72 in the regions where the first and second ribs overlap one another enables the diameter of each cooling channel to be set to the maximum physical value. Thus, the flow rate of the coolant can also be maximized, so that the cooling efficiency can be maximized. The thickness of the positive electrode can be minimized while ensuring efficient cooling. In addition, the same functions and effects as those of the first embodiment can be obtained.

The following is a description of a fuel cell device according to a third embodiment.

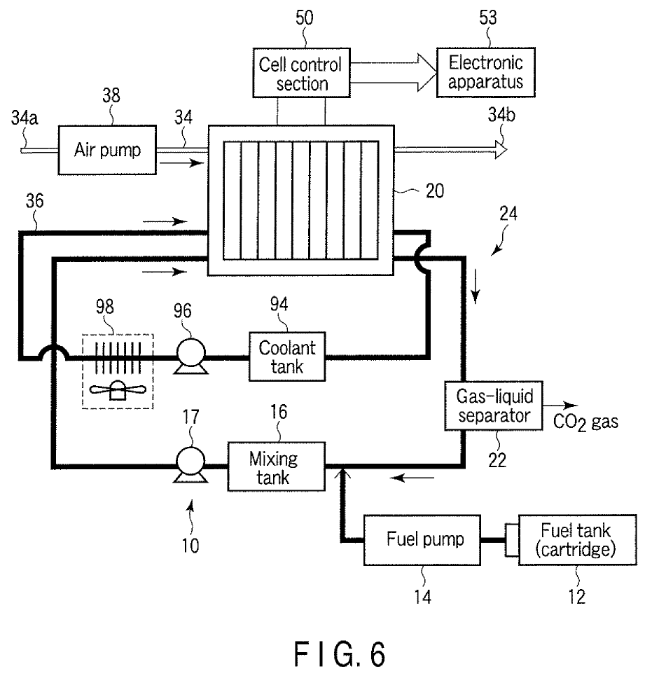

FIG. 6 schematically shows the configuration of a fuel cell device according to a third embodiment. According to the present embodiment, a circulatory system 24 includes an independent coolant channel 36 through which a coolant is supplied to a cell stack 20. The coolant channel 36 is formed of a pipe or the like, which extends in a loop through cooling channels of the cell stack 20. The coolant channel 36 is provided with a coolant tank 94 that contains, for example, water as the coolant, a liquid pump 97 connected to an output portion of the tank, and a heat exchanger 98 situated between the liquid pump and the cell stack. The heat exchanger 98 includes, for example, a plurality of radiator fins, which are arranged around a pipe that forms the coolant channel 36, and a cooling fan for delivering cooling air to the radiator fins. The heat exchanger 98 removes heat from the water that flows through the coolant channel 36, thereby cooling the water.

Other configurations of the fuel cell device of the third embodiment are the same as those of the foregoing first embodiment. Therefore, like reference numbers are used to designate like portions of these two embodiments, and a detailed description thereof is omitted.

When the liquid pump 96 is driven under the control of a cell control section 50 during the electricity generation by the fuel cell device, according to the third embodiment, the cooling water is supplied from the coolant tank 94 to the cell stack 20 through the coolant channel 36. As this cooling water flows through the cooling channels of the cell stack 20, it cools an anode separator and anode plates on the opposite sides thereof. Thereafter, the cooling water is returned to the coolant tank 94 through the coolant channel 36.

Also in the third embodiment constructed in this manner, there may be obtained a cell stack of a fuel cell, which can be cooled efficiently and made thinner, and a fuel cell device provided with the same.

While certain embodiments of the invention have been described, these embodiments have been presented by way of example only, and are not intended to limit the scope of the invention. Indeed, the novel methods and systems described herein may be embodied in a variety of other forms. Furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

For example, the fuel cell device may be configured so that air is supplied to the cell stack by diffusion and convection without using the air pump. The number of unit stacks in the cell stack is not limited to those described in connection with the above embodiments and may be varied as required. The fuel cell device according to this invention is also applicable to energy sources for various electronic apparatuses, such as personal computers, mobile devices, portable terminals, etc., and other apparatuses.

What is claimed is:

1. A cell stack of a fuel cell device, comprising:
a positive electrode including a plate-shaped anode separator, which is provided with a first contact surface and a second contact surface opposed to each other, and a pair of anode plates laminated opposite the first and second contact surfaces, respectively, of the anode separator;
a pair of negative electrodes laminated individually on the opposite sides of the positive electrode and each including a cathode plate opposed to each corresponding anode plate with a gap therebetween and a plate-shaped cathode separator provided with a contact surface opposed to the cathode plate; and
electrolyte layers each sandwiched between the anode plate and the cathode plate,
the anode separator including a plurality of groove-like first fuel channels which are formed in the first contact surface and through which a fuel is supplied to the anode plate corresponding thereto, a plurality of groove-like second fuel channels which are formed in the second contact surface and through which the fuel is supplied to the anode plate corresponding thereto, and cooling channels which are formed between the first and second contact surfaces and through which a coolant is circulated,
the cathode separator including a plurality of groove-like air channels which are formed in the contact surface and through which air is supplied to the cathode plate.

2. The cell stack of claim 1, wherein the anode separator comprises a plurality of first ribs, which are situated on either side of the first fuel channels and constitute the first contact surface, and a plurality of second ribs, which are situated on either side of the second fuel channels and constitute the second contact surface, and the cooling channels are formed in regions where the first and second ribs overlap one another.

3. The cell stack of claim 2, wherein the first fuel channels and the second fuel channels are formed symmetrically with respect to the cooling channels.

4. The cell stack of claim 2, wherein the first fuel channels and the second fuel channels are formed asymmetrically with respect to the cooling channels.

5. A cell stack of a fuel cell device which is formed by laminating a plurality of unit stacks to one another, each of the unit stacks comprising a positive electrode including a plate-shaped anode separator, which is provided with a first contact surface and a second contact surface opposed to each other, and a pair of anode plates laminated opposite the first and second contact surfaces, respectively, of the anode separator, a pair of negative electrodes laminated individually on the opposite sides of the positive electrode and each including a cathode plate opposed to each corresponding anode plate with a gap therebetween and a plate-shaped cathode separator provided with a contact surface opposed to the cathode plate, and electrolyte layers each sandwiched between the anode plate and the cathode plate, the anode separator including a plurality of groove-like first fuel channels which are formed in the first contact surface and through which a fuel is supplied to the anode plate corresponding thereto, a plurality of groove-like second fuel channels which are formed in the second contact surface and through which the fuel is supplied to the anode plate corresponding thereto, and cooling channels which are formed between the first and second contact surfaces and through which a coolant is circulated, the cathode separator including a plurality of groove-like air channels which are formed in the contact surface and through which air is supplied to the cathode plate, the plurality of unit stacks being laminated with the cathode separators thereof opposed to one another.

6. A fuel cell device comprising:
an electromotive section comprising a cell stack and configured to generate electricity in consequence of a chemical reaction;
a fuel tank configured to store a fuel;
a fuel supply section configured to supply the fuel from the fuel tank to the cell stack;
an air supply section configured to supply air to the cell stack; and
a coolant supply section configured to supply a coolant to the cell stack,
the cell stack comprising a positive electrode including a plate-shaped anode separator, which is provided with a first contact surface and a second contact surface opposed to each other, and a pair of anode plates laminated opposite the first and second contact surfaces, respectively, of the anode separator, a pair of negative electrodes laminated individually on the opposite sides of the positive electrode and each including a cathode plate opposed to each corresponding anode plate with a gap therebetween and a plate-shaped cathode separator provided with a contact surface opposed to the cathode plate, and electrolyte layers each sandwiched between the anode plate and the cathode plate, the anode separator including a plurality of groove-like first fuel channels which are formed in the first contact surface and through which a fuel is supplied to the anode plate corresponding thereto, a plurality of groove-like second fuel channels which are formed in the second contact surface and through which the fuel is supplied to the anode plate corresponding thereto, and cooling channels which are formed between the first and second contact surfaces and through which a coolant is circulated, the cathode separator including a plurality of groove-like air channels which are formed in the contact surface and through which air is supplied to the cathode plate.

7. The fuel cell device of claim 6, wherein the fuel supply section includes an anode channel through which the fuel is run via the first and second fuel channels of the cell stack, and the coolant supply section includes a coolant channel which diverges from the anode channel and through which some of the fuel is guided to the cooling channels of the cell stack.

8. The fuel cell device of claim 6, wherein the anode separator includes a plurality of first ribs, which are situated on either side of the first fuel channels and constitute the first contact surface, and a plurality of second ribs, which are situated on either side of the second fuel channels and constitute the second contact surface, and the cooling channels are formed in regions where the first and second ribs overlap one another.
